(19) United States
(12) Patent Application Publication
(10) Pub. No.: US 2025/0272158 A1
(43) Pub. Date: Aug. 28, 2025

(54) SCHEDULING HYBRID SHARING OF COMPUTE RESOURCES BETWEEN REAL-TIME WORKLOADS

(71) Applicant: Microsoft Technology Licensing, LLC, Redmond, WA (US)

(72) Inventors: Xenofon FOUKAS, Cambridge (GB); Bozidar RADUNOVIC, Cambridge (GB)

(73) Assignee: Microsoft Technology Licensing, LLC, Redmond, WA (US)

(21) Appl. No.: 18/777,281

(22) Filed: Jul. 18, 2024

Related U.S. Application Data
(60) Provisional application No. 63/557,372, filed on Feb. 23, 2024.

(51) Int. Cl. G06F 9/50; G06F 9/455; G06F 9/48

(52) U.S. Cl. CPC G06F 9/5077; G06F 9/45558; G06F 9/4881; G06F 2009/4557; G06F 2009/45595

(57) ABSTRACT

The present disclosure relates to systems, methods, and computer-readable media for implementing a hybrid scheduler for vRAN compute sharing. The systems described herein involve a hybrid scheduling system that considers KPIs and telemetry data associated with usage of vCPUs on a vRAN VM, container, or other service construct and determines estimated runtimes for tasks of workloads running on the vCPUs. The hybrid scheduling system may generate scheduling instructions to be used by an operating system on the server device to schedule allocation of computing resources to any number of vCPUs hosted by the server device. The hybrid scheduling system provides features that enables optimization of not only physical layer processing tasks, but a holistic approach that involves optimizing scheduling of tasks associated with multiple processing layers of VMs, and particular vRAN workload VMs.

### CROSS REFERENCE TO RELATED APPLICATIONS

This application claims benefit and priority to Provisional Application No. 63/557,372, filed on Feb. 23, 2024, the entirety of which is incorporated herein by reference.

### BACKGROUND

Virtualized Radio Access Networks (vRANs) are part of the mobile network architecture that provides wireless connectivity to mobile users in the form of base stations. In contrast to previous mobile network generations, in which base stations are typically implemented as specialized hardware boxes, modern mobile networks rely on fully virtualized RAN functions (e.g., in the form of containers), running on commodity x86 servers at the edge. Many vRAN workloads involve a real-time requirement in which processing of signals must be completed within a strict deadline. When this requirement is not met, services will often experience degraded performance and communications will often be dropped or become disconnected.

Avoiding performance degradation and disconnections is important in providing reliable telecommunication services, particularly since modern communication networks are often required to provide services at a very high level of reliability with low latency. In order to ensure that a vRAN workload can meet these strict service requirements, a conventional approach within the industry is to use isolated compute resources such as dedicated compute cores, dedicated cache, dedicated RAM, and other computing resources in such a way that a machine on which a vRAN is running is equipped host the vRAN at its peak capacity.

While this overprovisioning of resources in accordance with demands of peak capacity ensures that a vRAN will effectively run during periods of peak capacity, it is often a very inefficient use of resources during other periods of time when the vRAN is not running at peak capacity. Indeed, it is not uncommon that 80% of computing resources that are allocated to a vRAN workload are left unutilized, resulting in a very expensive network of devices that are only used at their peak capacity during relatively few periods of time. This results in significant power usage as well as a very robust computer network that is largely unutilized.

To address these issues, some scheduling systems include methods for sharing compute resources between the vRAN functions and other workloads. For example, these other methods control the amount of physical CPU resources that can be shared between the vRAN and other workloads, while guaranteeing that the real-time constraints of the vRAN processing will not be violated. The level of integration these methods require, however, is generally prohibitive. For example, these other scheduling systems are often tailored to a specific RAN implementation of a RAN vendor—and therefore need cooperation of the RAN vendor to expose the metrics required for scheduling the vRAN workloads. Ensuring this level of integration when a system includes vRANs from multiple vendors is often difficult and inefficient.

These and other drawbacks exist in modern telecommunications networks.

### BRIEF DESCRIPTION OF THE DRAWINGS

FIG. 1 illustrates an example telecommunications network environment including a hybrid scheduling system implemented on a server device within a cloud computing system.

FIG. 2 illustrates an example server device on which the hybrid scheduling system can be implemented in accordance with one or more embodiments.

FIG. 3 illustrates an example implementation of the hybrid scheduling system in which computing resources are scheduled for a set of real-time workload tasks in accordance with one or more embodiments.

FIG. 4 illustrates an example series of acts related to enabling multiple real-time workloads of a vRAN VM to be processed without violating deadline scheduling in accordance with one or more embodiments.

FIG. 5 illustrates certain components that may be included within a computer system.

### DETAILED DESCRIPTION

This disclosure relates to the hybrid sharing of computing resources between real-time workloads on a server node. In one or more embodiments described herein, the disclosure specifically relates to using a hybrid scheduling system to coordinate and schedule computing resources between two or more virtual radio access network (vRAN) real-time workloads as well as with additional workloads (e.g., vRAN and/or non-vRAN workloads) for processes (e.g., virtual machines, containers, applications) also running on the same computing device.

Indeed, as will be discussed in further detail below, the hybrid scheduling system may be implemented on a server node to observe operating conditions of vCPUs of various processes (e.g., virtual machines or VMs). The hybrid scheduling system may designate real-time cores (R-cores) and shared cores (S-cores) of one or more virtual machines (VMs or vCPUs) and map those virtual cores to physical cores of the server node. The hybrid scheduling system may further derive various system key performance indicators (KPIs) based on uplink and downlink observed network traffic. The hybrid scheduling system can then generate scheduling instructions for the R-cores and S-cores of the VMs to perform tasks of two or more concurrent real-time workloads—in addition to other shared workloads—across the mapped physical cores while maintaining the real-time constraints of the vRAN processing.

Features and functionality of embodiments described herein provide examples and implementations that illustrate how the hybrid scheduling system can generate scheduling instructions that an operating system (OS) scheduler can use in scheduling allocation of computing resources to concurrent real-time workload processes in addition to other shared workload processes. The implementations described herein include features and functionality that optimize utilization of computing resources while ensuring that deadline-driven tasks (e.g., real-time tasks) can be performed within strict deadlines or constraints.

As background, virtualized Radio Access Networks (vRANs) are part of the mobile network architecture that provides wireless connectivity to mobile users in the form of virtualized RAN components. Fifth generation (5G) mobile networks and beyond often utilize fully virtualized RAN (vRAN) functions (e.g., in the form of containers and/or virtual machines), running on commodity x86 servers at the edge. One characteristic of vRAN workloads is (soft) real-time requirement, e.g., the signal processing operation for a transmission and/or reception must be completed within a strict deadline (0.125 us-1 ms), otherwise users experience degraded performance at best or a complete disconnection from the network in the worst case.

Avoiding performance degradation is important for telecommunications networks. For example, telecommunications networks (e.g., 5G networks) are typically required to provide services with very high levels of reliability (e.g., up to “5 nines” or 99.999% read availability) and low latency. To ensure that a vRAN component can meet these strict deadlines, a standard practice of the industry is to use isolated compute resources (dedicated CPU cores, dedicated cache and DRAM, etc.) and to provision the vRAN for peak capacity.

While isolated computing resources that are fully dedicated to corresponding virtual computing resources (e.g., vCPUs) is an effective way to streamline processing tasks and ensure a high measure of reliability, this can be an inefficient and overly expensive utilization of computing resources. Indeed, during non-peak periods in which traffic is not high, many computing resources will go unused when they could otherwise be shared with processes or VMs that are also hosted by a server device having the vRAN VMs thereon. This can be especially problematic with the often-bursty workload of network traffic (particularly in 5G networks), essentially forcing a significant number of computing resources to be reserved for vRAN services at all times.

Due to the isolated deployment configuration of the solutions that use dedicated deployment, conventional scheduling frameworks do not provide an effective and/or reliable mechanism for the prediction of the CPU requirements of vRAN tasks at runtime. In the more general space of the cloud, there exist a number of scheduling frameworks for enabling the collocation of low-latency workloads. However, none of those solutions are aware of deadlines and the worst-case execution time (WCET) of tasks, meaning that in the worst case the tail latency of processing vRAN tasks could still be high, leading to missed deadlines and low reliability (at most “3 nines” or 99.9%).

Moreover, most of those solutions require the collocated workloads to be implemented using specific constraining application programming interfaces (APIs), meaning that generic workloads running on containers or virtual machines (VMs) cannot be deployed on top of them. Finally, there exist a number of deadline scheduling framework solutions in the space of embedded systems. However, such solutions need to provide hard real-time guarantees (e.g., a deadline must never be missed) and therefore their design is based on the assumption that no other workload is running on the same hardware. If these assumptions are violated, these solutions would no longer work.

Solutions to these issues have been at-least partially presented by scheduling systems that view vCPUs of different workloads of different services (e.g., VMs, containers), evaluate telemetry data that is agnostic to some of the individual processing details of the particular vRAN (e.g., without considering specific processing layers or that is isolated to the physical processing layer), and determine estimated runtime durations for different discrete computing periods. These estimations are then used to generate scheduling instructions that an OS scheduler can use in allocating computing resources between any number of vCPU threads independent of specific processing tasks and in a manner that optimizes allocation of physical computing resources between virtual components hosted by a server device.

These systems—however—rely on various assumptions. First, such systems are incapable of sharing compute resources between two or more real-time vRAN functions. For example, ensuring that the very demanding workloads of vRAN functions do not end up on the same physical CPU processors or cores requires a shared knowledge of the placement of each of those workloads. This assumes that vRAN vendors share that knowledge upon deployment, which is often not the case. Assuming that the vRAN vendor has knowledge of the configuration of the other vRAN workloads can lead to various issues and generally violates the paradigm of multi-tenancy in a cloud environment—such as is common in a telecommunication network.

Second, a typical CPU scheduler often requires KPIs be collected in real-time from the vRAN functions. Such KPIs often indicate the amount of uplink traffic and downlink traffic at a very fine time granularity. However, accessing this data generally requires the cooperation of vRAN vendors to expose the required KPIs. Assuming that vRAN vendors are willing and able to expose this information can lead to processing bottlenecks and other failures. As such, these CPU schedulers only function when they are integrated into the vRAN functions of vRAN vendors and are rigidly tailored to a vendor's specific RAN implementation.

To address these issues, the systems and methods discussed herein include a hybrid scheduling system that does not need to be integrated into the vRAN functions of vendors, but instead exists as a separate process. For example, and as will be discussed in greater detail below, the hybrid scheduling system assumes that a vRAN is running inside of a VM. The hybrid scheduling system can operate from the host OS level to control the vCPUs of the whole VM—thereby treating the vRAN as a black box without any additional knowledge or vendor cooperation required.

In more detail, the hybrid scheduling system avoids the assumptions made by previous systems by 1) utilizing a CPU paravirtualization approach that allows for the initial creation of a VM to distinguish required CPU cores into real-time cores (R-cores) and shared cores (S-Cores), and by 2) mirroring all traffic that goes in and out of a vRAN VM to infer traffic-based KPIs that are then used in creating scheduling instructions for the R-cores and S-cores mapped to physical CPU cores.

As illustrated in the foregoing discussion and as will be discussed in further detail herein, the present disclosure utilizes a variety of terms to describe features and advantages of methods and systems described herein. Some of these terms will be discussed in further detail below.

As used herein, a cloud computing system or distributed computing system may be used interchangeably to refer to a network of connected computing devices that provide various services to computing devices (e.g., customer devices). For instance, as mentioned above, a cloud computing system can include a collection of physical server devices (e.g., server nodes) organized in a hierarchical structure including clusters, computing zones, virtual local area networks (VLANs), racks, fault domains, etc. In one or more embodiments described herein a portion of the cellular network (e.g., an edge network, datacenter) may be implemented in whole or in part on a cloud computing system. In one or more embodiments a data network may be implemented on the same or on a different cloud computing network as the portion of the cellular network. In addition, in one or more embodiments, a telecommunications network is implemented using services that are provided on server nodes of the cloud computing system.

As used herein, “telemetry data” refers to data that is logged or otherwise collected by an entity within a telecommunications network. For example, in one or more implementations described herein, telemetry data refers to any data that is collected by and/or received from a virtual machine in real-time. In one or more embodiments, the telemetry data may include observed or tracked runtimes of various tasks, which may be used to determine one or more runtime durations for a given vCPU, which will be discussed in further detail below. In one or more embodiments, telemetry data includes 3GPP telemetry data. In one or more implementations, telemetry data includes various key performance indicators (KPIs) (e.g., queue sizes, signal quality of UEs). In some implementations, telemetry data and KPIs are used interchangeably.

As used herein, a “configuration parameter” may refer to one or more parameters associated with limitations or functionality of a vCPU and/or associated vRAN virtual machine. In one or more embodiments, a configuration parameter indicates characteristics or requirements associated with performance of a task or workload. For example, in one or more embodiments, a configuration parameter includes indicated durations or deadlines associated with performance of a task. For instance, a configuration parameter may include a period parameter indicating a duration of time within which any given task can run using a vCPU. This duration of time may refer to a maximum time that can be configured or allocated to a vCPU to perform a discrete task. As another example, a configuration parameter may include a deadline parameter indicating a duration of time that is a maximum amount of time within which a specific task or a specific given task of a corresponding workload must be completed by a vCPU. In this instance, the deadline parameter may refer to a maximum period of time within a period parameter for which a given task must be performed. In one or more embodiments, the configuration parameters are received or otherwise obtained when a virtual machine is configured and may be based on the implementation and configuration of the vRAN virtual machine.

In one or more embodiments described herein, a runtime duration is determined for a task. As used herein, a “runtime duration” may refer to a period of time for which a vCPU is assigned or allocated physical resources (e.g., CPU resources) to perform a given task (or tasks). For example, a runtime duration may refer to a subset of time or portion of time within a deadline parameter for which computing resources are made available to (e.g., allocated to) a vCPU and/or a vRAN generally. Additional detail associated with determining the duration and/or timing of the runtime duration will be discussed in connection with various examples below.

As used herein a workload includes a set of tasks, processes, or other computational activities that a vCPU executes in accordance with instructions. A workload may include any number of tasks, which may be performed in sequence or in parallel based on scheduling instructions associated with performing the workload (or tasks of the workload). Examples of tasks of a workload may include running applications, processing data, handling requests, and managing system resources. In one or more embodiments, tasks of a workload are in accordance with defined standards (e.g., 3GPP standards).

In some implementations, a workload may be a “real-time workload.” A real-time workload includes tasks that are required to be completed within a strict deadline (e.g., between 0.125 microseconds (μs) and 1 millisecond (ms)). Real-time workloads tend to be processor intensive. In additional implementations, a workload may be a “best-effort workload.” Best-effort workloads may include tasks that can be completed within a variable amount of time. In one or more embodiments, a best-effort workload may be processed on the same CPU as a real-time workload, although two real-time workloads may not be processed together.

As used herein, a “real-time core” or “R-core” refers to a designation associated with resources of a vCPU. In one or more embodiments, an R-core is a designation for vCPU resources that can only be used to process one real-time workload from one vRAN VM at a time. In other words, an R-core cannot be shared by any other VM or real-time workload. As used herein, a “best-effort core” or “shared core” or “S-core” refers to an additional designation associated with resources of a vCPU. In one or more embodiments, an S-core is used to process best-effort workloads and may be collocated with an R-core (or an additional S-core) of a separate VM. In one or more embodiments, as discussed further below, the hybrid scheduling system maps R-cores and S-cores of vCPUs of vRAN VMs to physical processors or CPUs of a server device.

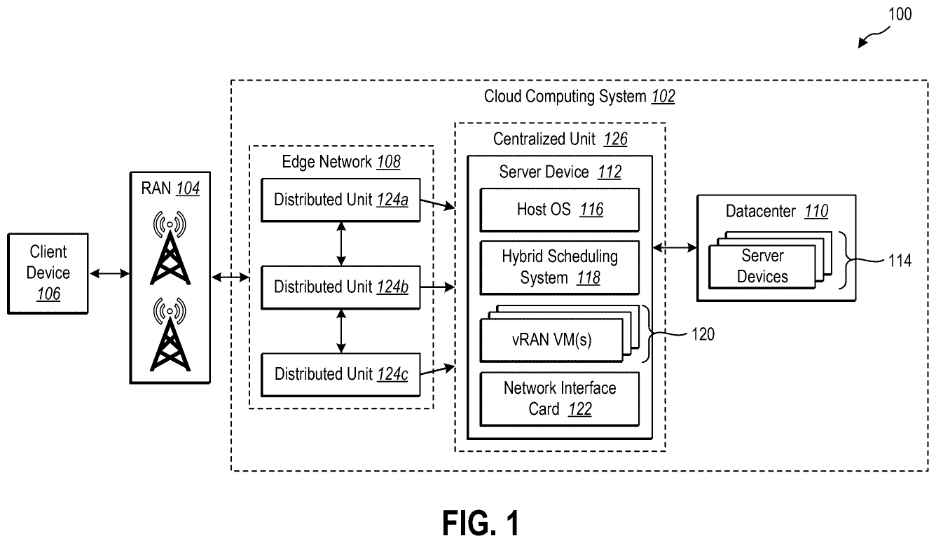

Additional detail will now be provided regarding systems described herein in relation to illustrative figures portraying example implementations. For example, FIG. 1 illustrates an example environment 100 for implementing features and functionality of a hybrid scheduling system in accordance with examples described herein.

As shown in FIG. 1, the environment 100 may illustrate portions of a communication environment (e.g., a cellular network, such as a 5G cellular network). For example, the environment 100 may include zones or components of a cloud computing system 102, such as a radio access network (RAN) 104, core network, internal infrastructure, and other components of a cloud computing system 102. The components of the environment 100 may collectively form a public or private cellular network, which includes a RAN 104, core network, data network, and other components of a cloud computing system 102.

In the example shown in FIG. 1, the environment includes a client device 106 (e.g., a user equipment, such as a mobile device), a RAN 104 including one or more physical RAN components (e.g., base stations), and different computing zones of a cloud computing system 102. In one or more embodiments described herein, the cloud computing system 102 includes distributed units (DUs) 124a, 124b, 124c implemented on an edge network 108 as well as other server devices 114 implemented at a datacenter 110. The cloud computing system 102 also includes a centralized unit (CU) 126 hosting a server device 112 including a host OS 116, a hybrid scheduling system 118, multiple vRAN VMs 120 and at least one network interface card (NIC) 122.

In one or more embodiments, the vRAN VMs 120 provide virtual RAN functionality, such as discussed above. In additional implementations, the CU 126 may involve core network components or other virtualized components of the cloud computing system 102 or mobile network generally.

In one or more embodiments, the server device 112 includes other types of services, such as containers, applications, or other services for which the hybrid scheduling system 118 may facilitate scheduling tasks in accordance with one or more embodiments. Thus, while one or more embodiments described herein refer specifically to scheduling real-time workload tasks on a variety of VM types (and specifically vRANs), it will be appreciated that other implementations may involve scheduling tasks on containers or other types of workload entities that may be implemented on server devices and/or which may include real-time scheduling of tasks and workloads.

In addition, while FIG. 1 illustrates an example environment 100 where the hybrid scheduling system 118 is implemented on the server device 112 of the CU 126, this is provided by way of example and not limitation. Indeed, one or more embodiments described herein may involve the hybrid scheduling system 118 being implemented on a device of an edge network 108, such as on one or more of the DUs 124a-124c having real-time processing requirements with strict deadlines within which packets need to be processed. Other examples of the hybrid scheduling system 118 may be implemented on devices of a core network, data network, edge network, or on any service of a telecommunications network (or other network that may be implemented on the cloud computing system 102) where the service(s) has tasks or workloads that have low latency or other time-sensitive requirements.

As mentioned above, the hybrid scheduling system 118 may provide features and functionality related to scheduling real-time tasks of workloads for vRAN VMs on the server device 112 in a manner that enables computing resources to be shared between different vCPUs (and/or between different vRAN VMs) without causing certain deadlines to be missed. For example, as will be discussed in further detail herein, a hybrid scheduling system 118 may designate R-cores and S-cores of vCPUs, infer KPIs or telemetry data from network traffic to and from the server device 112, determine duration(s) of task(s) to be performed by the vRAN VMs, and generate scheduling instructions based on the determined duration(s) to enable an OS scheduler to efficiently schedule the tasks and to cause computing resources (e.g., physical cores (CPUs)) to be shared between vCPUs of multiple vRAN VMs.

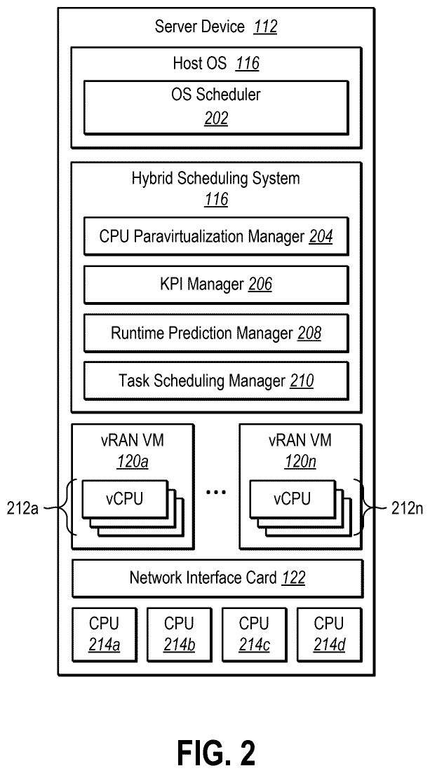

FIG. 2 provides a more detailed overview of the server device 112 on which the hybrid scheduling system 118 may be implemented in accordance with one or more embodiments. For example, as shown in FIG. 2, the server device 112 includes the host operating system (OS) 116 having an OS scheduler 202 (e.g., a deadline scheduler) implemented thereon. The host OS 116 may manage high level operations of any number of VMs hosted by the server device 112. For instance, the host OS 116 may manage a hypervisor on or associated with the host OS 116, which may create and/or otherwise manage operation of the vRAN VMs 120a-120n on the server device 112. Among other things, the host OS 116 may include the OS scheduler 202 (or deadline scheduler) that is tasked with coordinating resources between the one or more vRAN VMs 120a-120n that may share certain computing resources with other VMs.

For example, as shown in FIG. 2, the server device 112 is hosting the plurality of vRAN VMs 120a-120n. In one or more implementations, the vRAN VMs 120a-120n have vCPUs 212a-212n, respectively, that have time-sensitive (e.g., deadline driven) workloads in which tasks must be performed within a hard deadline. In many cases, this involves processing communication packets that are being communicated and processed in real-time and which have protocols that define specific deadlines within which the packets need to be processed and/or transmitted. In one or more embodiments described herein, the hybrid scheduling system 118 is particularly focused on ensuring that the vRAN VMs 120a-120n are performing tasks within deadlines as a priority and determining when computing resources that are tasked to perform processing tasks may have idle cycles or downtime that may be allocated to other (non-real-time) workloads.

In one or more implementations, the vRAN VMs 120a-120n include vCPUs 212a-212n, respectively, that may be associated with or mapped to one or more of the physical cores (e.g., physical CPUs 214a, 214b, 214c, 214d) of the server device 212 for a given period of time to execute tasks of respective workloads. While some workloads processed by the vRAN VMs 120a-120n have specific deadlines (i.e., as with real-time workload tasks), other workloads processed by the vRAN VMs 120a-120n may not have specific deadlines within which processing tasks can be performed (i.e., as with best-effort workloads) and thus have increased flexibility in scheduling tasks to be performed within periods of time. As will be discussed in further detail below, the tasks of these workloads without specific deadlines may be performed across one or more periods of time and are therefore well-suited to be performed by physical cores that are being shared by vRAN VMs 120a-120n.

As shown in FIG. 2, the server device 112 includes a hybrid scheduling system 118. As shown in FIG. 2, this hybrid scheduling system 118 is not implemented as part of the respective vRAN VMs 120a-120n. Thus, the hybrid scheduling system 118 may not necessarily have detailed knowledge of specific tasks or threads that are performed by the vCPUs 212a-212n, but rather evaluates telemetry data and KPIs associated with the vCPUs themselves (e.g., without consideration of individual tasks or which processing layers are involved in performing specific tasks) to determine estimated runtimes that may be used in generating scheduling instructions for the CPUs 214a-214d.

The hybrid scheduling system 118 includes a number of components for performing features and functionality of implementations described herein. For example, as shown in FIG. 2, the hybrid scheduling system 118 includes a CPU paravirtualization manager 204, a KPI manager 206, a runtime prediction manager 208, and a task scheduling manager 210. The functionality of each of the managers 204-210 will now be discussed in more detail.

As just mentioned, and as shown in FIG. 2, the hybrid scheduling system 118 includes the CPU paravirtualization manager 204. In one or more implementations, the CPU paravirtualization manager 204 designates R-cores and S-cores within a vCPU. As discussed above, an R-core guarantees that no other real-time workload of another VM will be running on the same physical core. An S-core is a best-effort core that can be collocated with an R-core of another VM. The CPU paravirtualization manager 204 can map the designated R-cores and S-cores within the vCPU to computing resources of a physical CPU (e.g., one or more of the CPUs 214a, 214b, 214c, and/or 214d).

In more detail, during the creation process of a vRAN VM, the CPU paravirtualization manager 204 allows for a number of R-cores and a number of S-cores to be specified in connection with that vRAN VM. In response to receiving these specifications, the CPU paravirtualization manager 204 designates a corresponding number of R-cores and S-cores of the one or more vCPUs for that VM. In one or more embodiments, the CPU paravirtualization manager 204 further acts as a hypervisor and maps computing resources of one or more physical CPUs (e.g., the CPUs 214a-214d) to correspond to the number of R-cores and S-cores.

In one or more implementations, the CPU paravirtualization manager 204 further performs admission control in connection with the CPU resources mapped to the number of R-cores and S-cores. For example, the CPU paravirtualization manager 204 can ensure that the vRAN VM associated with the R-cores and S-cores is powered on without overcommitting the resources of the physical CPUs mapped to the R-cores and S-cores. In one or more implementations, the CPU paravirtualization manager 204 performs admission control by generating, maintaining, and updating a mapping policy that reflects the restrictions of the R-cores and S-cores designated in connection with a vRAN VM. For example, upon designation of an R-core in connection with a vRAN VM, the CPU paravirtualization manager 204 can update the mapping policy for the vCPU of that vRAN VM to reflect that no other real-time workloads may be assigned to the physical CPU to which the R-core is mapped while running a real-time workload for that vRAN VM.

As mentioned above, and as shown in FIG. 2, the hybrid scheduling system 118 includes the KPI manager 206. In or more implementations, the KPI manager 206 receives, infers, or otherwise obtains telemetry data and KPIs from the vRAN VMs 120a-120n as well as any other additional VMs running on the server device 112. As mentioned above, telemetry data can refer to any data associated with one or more vCPUs and parameters associated with operation of the vCPUs.

As discussed above, the hybrid scheduling system 118 allows for the vRAN VMs 120a-120n to be operated as “black boxes” without requiring any RAN vendor cooperation in exposing required KPIs. Despite this, for the OS scheduler 202 to function optimally, certain KPIs (e.g., amount of uplink or downlink traffic) need to be collected in real-time from the vRAN VMs 120a-120n. Because the KPI manager 206 cannot access this information directly within the vRAN VMs 120a-120n, the KPI manager 206 can instead leverage the network interface card 122 of the server device 112 to infer these KPIs.

For example, in one or more implementations, the KPI manager 206 can leverage an embedded switch (e.g., an eSwitch) on the network interface card 122 to mirror all network traffic (e.g., both uplink traffic and downlink traffic) that is going in and out of a particular vRAN VM 120a to and from other virtual functions of the network interface card 122. In more detail, the KPI manager 206 can mirror traffic flows of interest, such as the traffic flows that interact with interfaces of the vRAN VM 120a. The KPI manager 206 can mirror the uplink interface and the downlink interface of the vRAN VM 120a, and then run an agent on the host OS 116 that taps into those mirrored interfaces to view the traffic that is going to and coming from the vRAN VM 120a in both directions. In other words, the KPI manager 206 can utilize this mirroring to tap into uplink traffic coming to the vRAN VM 120a from the DUs 124a-124c on the edge network 108 and to tap into the downlink traffic leaving the vRAN VM 120a via the CU 126. In at least one implementation, the KPI manager 206 can tap into this traffic in a lightweight manner such as with an eBPF probe (e.g., an extension point defined by the kernel where a Berkeley Packet Filter program can be attached).

In one or more implementations, the KPI manager 206 utilizes various techniques to infer KPIs and/or other telemetry data from this mirrored traffic. For example, the KPI manager 206 derives KPIs related to user throughput from downlink traffic from the CU 126 to the DUs 124a-124c using packets captured at the mirrored downlink interface of the vRAN VM 120a. The KPI manager 206 can utilize these captured packets as a direct proxy of the virtual distributed unit VM load.

In one or more implementations, the KPI manager 206 can also collect data about the timing of the base station (e.g., the RAN 104) utilizing the headers of fronthaul packets within the cloud computing system 102. For example, the KPI manager 206 can utilize these headers to determine if one or more of the DUs 124a-124c will be doing uplink or downlink processing. In at least one implementation, the KPI manager 206 can utilize this information as a direct proxy of the virtual DU load.

In one or more implementations, inferring KPIs based on uplink traffic (e.g., user traffic from the DUs 124a-124c to the CU 126) is less direct. For example, the KPI manager 206 cannot simply utilize information from fronthaul packet headers in the uplink traffic because data packets traveling in this direction are not indicative of user traffic—even though the opposite may be true with downlink traffic from the centralized unit 126 to the distributed units 124a-124c. Instead, the KPI manager 206 can infer user traffic load in uplink traffic based on energy level samples taken from the uplink traffic.

In more detail, the KPI manager 206 can take “IQ” samples from the uplink traffic flow at regular intervals. In one or more embodiments, an IQ sample refers to a representation of a signal's in-phase (I) and quadrature (Q) components. For example, the in-phase component of a signal taken from an uplink traffic flow represents the real part of the signal and corresponds to the signal's amplitude or strength at a specific point in time. The quadrature component of a signal taken from an uplink traffic flow represents the imaginary part of the signal and is phase-shifted by 90 degrees relative to the I component. In at least one implementation, combining the I and Q components of the signal creates a complex number that fully describes the signal.

As such, the KPI manager 206 can utilize the IQ samples that the fronthaul packets carry in the uplink traffic flow to infer uplink traffic load. For example, if the IQ samples of the fronthaul packets indicate a high energy, the KPI manager 206 can infer that the vRAN VM 120a will have uplink traffic to process. Conversely, if the IQ samples of the fronthaul packets indicate a low energy, the KPI manager 206 can infer that there will be no uplink traffic for the vRAN VM 120a to process.

Additionally, the KPI manager 206 can collect KPIs in connection with downlink traffic traveling from the distributed units 124a-124c and the RAN 104. For example, in some implementations, this traffic includes already-processed responses to requests originally issued by the client device 106. As such, the KPI manager 206 cannot utilize information from fronthaul packet headers in this traffic to determine KPIs. Instead, as with the traffic from the centralized unit 126 to the distributed units 124a-124c the KPI manager 206 can utilize IQ samples to determine energy levels within this traffic.

In addition to inferring traffic load KPIs from the uplink and downlink traffic, the KPI manager 206 can receive or otherwise obtain telemetry data from the vRAN VMs 120a-120n, as well as any other VM running on the server device 112. For example, the KPI manager 206 can determine, identify, or otherwise obtain configuration parameters, including a processing period (or simply period) associated with a vCPU or workload. A processing period may refer to a duration of time within which any discrete processing task is to be performed. In one or more embodiments, the period is a predetermined period of time determined by a vendor of the VM or specific vRAN function (e.g., vRAN component). By way of example, a period may refer to a fixed or predetermined period of time, such as 500 microseconds, 1 millisecond, or other duration of time as may serve a particular embodiment of an application, VM, or particular workload. In one or more embodiments, the processing period is referred to as a period parameter that is passed to the OS for use in performing scheduling operations and associating tasks with processing cycles of particular computing resources.

In one or more embodiments, the configuration parameters include a deadline associated with a duration of time in which a task must be performed to be considered successful. In the context of real-time functions (e.g., audio/video calls), a deadline is often a protocol-defined parameter indicating a specific duration of time in which a packet must be processed or in which a discrete task of a packet processing workload must be processed. In the event a deadline is not met, one or more packets can be dropped, service may be interrupted, or a session may be discontinued. In short, the real-time service will degrade and provide a notably worse experience for individuals or applications using the real-time application/services.

In one or more embodiments, the telemetry data collected by the KPI manager 206 includes runtime data (e.g., thread runtimes), which may refer to known or estimated runtimes for packets to be processed, as well as historical data associated with previous packet processing that has been collected and which may be used by the KPI manager 206 in estimating future runtimes. In one or more embodiments, the telemetry data includes information about packets, such as a robustness of the packet, which may be indicative of a runtime (e.g., longer estimated runtimes for more robust packets, shorter estimated runtimes for less robust packets).

In addition to the above examples, the telemetry data may refer to any information provided by the VMs to the KPI manager 206 that may be used to determine a runtime for a given packet or task of a workload. This may include vCPU utilization information generally, RAN function data, thread runtimes, and other information associated with the vCPU generally. As noted above, the telemetry data may be agnostic to specific processes or processing layers and may be inclusive of information involving two or more processing layers, such as a physical layer (PHY), a radio resource allocation/reliability layer (MAC/RLC), a convergence/security layer (PDCP), a quality of service layer (SDAP), and a mobile core communication (NAS) layer.

As mentioned above, and as shown in FIG. 2, the hybrid scheduling system 118 additionally includes the runtime prediction manager 208. The runtime prediction manager 208 may utilize the telemetry data—in addition to KPIs inferred by the KPI manager 206—and any other additional data accessible to the hybrid scheduling system 118 to determine an estimated runtime (or runtime parameter) associated with an estimated time within a given period (and within a deadline) that a task is estimated to be completed. In one or more embodiments, the runtime prediction manager 208 determines runtime parameters for any number of tasks of an associated workload. For example, where processing a packet involves performing a set of tasks in a specific order or series, the runtime prediction manager 208 may determine a runtime for each of the tasks of the workload for the associated periods within which the tasks are to be performed. Where multiple vCPUs are involved, the runtime prediction manager 208 may similarly determine runtimes for each of the tasks to be performed on each of the vCPUs. Additionally, where R-cores and S-cores of vCPUs (e.g., the vCPUs 212a-212n) are associated with tasks of a workload, the runtime prediction manager 208 can determine runtimes for each of the tasks across the R-cores and S-cores.

The runtime prediction manager 208 may determine an estimated runtime in a variety of ways. For example, in one or more embodiments, the runtime prediction manager 208 generates or otherwise obtains a lookup table indicating runtimes for associated tasks based on information about the tasks/workload. In this example, certain tasks (e.g., common tasks) may have a known or predictable runtime that the runtime prediction manager 208 may identify from a lookup table with reasonable accuracy. Rather than calculate a runtime, the runtime prediction manager 208 may simply look it up and pass the runtime information to the OS scheduler 202 to use in scheduling the computing resources.

As another example, the runtime prediction manager 208 may use a conservative approach that involves determining whether a packet is to be processed within a given period (e.g., duration of computing cycle(s)). For example, where a packet exists and needs to be processed, the runtime prediction manager 208 may determine a maximum runtime value that tracks the duration parameter (or duration of the period) that would disallow computing resources of the vCPU performing the task(s) to be shared with other vCPUs from the same or different VMs. Alternatively, where a packet does not exist for a given period of time, the runtime prediction manager 208 may determine a minimum runtime value (e.g., a near-zero runtime value) that would allow computing resources to be shared with other vCPUs from the same or different VM for the vast majority or the entire duration of the period in which the runtime is set at the minimum value.

In one or more embodiments, the runtime prediction manager 208 uses a trained model, such as a machine learning model, in estimating runtimes for vCPU tasks. For example, in one or more embodiments, a machine learning model (or other form of dynamic prediction model(s)) receives historical telemetry data over time including information such as a type of task and associated runtime, which the machine learning model may use in training one or more algorithms to more accurately predict runtimes for similar types of tasks (or tasks having a certain set of characteristics).

As further shown in FIG. 2, the hybrid scheduling system 118 includes the task scheduling manager 210. The task scheduling manager 210 may determine blocks of time within periods for which the vCPUs 212a-212n will not be using allocated computing resources. For example, where a determined runtime parameter is only determined to be 20% of a given period, the task scheduling manager 210 may determine that the other 80% of the period may be shared with another vCPU.

In addition to determining specific blocks of available vCPU capacity, the task scheduling manager 210 may determine how many vCPUs are available over multiple periods. For example, in the event that a workload spans multiple periods and has a plurality of associated tasks to be performed in series, the task scheduling manager 210 may determine stretches of multiple periods in which one or more vCPUs of a given VM will be idle, which information may be used in generating scheduling instructions that may be passed to the OS scheduler 202.

As shown in FIG. 2, it will be appreciated that the hybrid scheduling system 118 refers to a controller or off-OS scheduler that coordinates with the OS scheduler 202 to allocate computing resources between different workloads that may be performed using different vCPUs. This is beneficial in implementations where the OS scheduler 202 naively allocates computing resources to computing tasks as they are received rather than considering ordered tasks of multi-stage workloads that need to be completed within a given deadline. Indeed, by implementing the hybrid scheduling system 118 that receives KPI information for multiple VMs, the hybrid scheduling system 118 can consider entire workflows and associated deadlines to assist the OS scheduler 202 in coordinating allocation of computing resources. This helps avoid scenarios in which the OS scheduler 202 naively or inefficiently assigns vCPUs to corresponding compute cores in a manner that causes processing delays or interruptions of services.

In addition to the above-details associated with determining estimated runtimes and generating instructions that enable the OS scheduler 202 to determine an effective and efficient allocation of computing resources to respective vCPUs, other implementations may be performed in a similar manner as described in U.S. patent application Ser. No. 16/941,033, entitled “SHARING OF COMPUTE RESOURCES BETWEEN THE VIRTUALIZED RADIO ACCESS NETWORK (VRAN) AND OTHER WORKLOADS” filed on Jul. 28, 2020, the entirety of which is incorporated by reference.

Furthermore, while one or more embodiments described herein relate to a hybrid scheduling system for generating instructions that facilitate sharing computing resources between real-time workloads, the hybrid scheduling system may additionally share features and functionalities described in connection with a real-time scheduling system as described in U.S. patent application Ser. No. 18/657,449, entitled “SCHEDULING SHARING OF COMPUTE RESOURCES BETWEEN WORKLOADS” filed on May 7, 2024, the entirety of which is incorporated by reference.

By way of example and as discussed in the related disclosure, in one or more embodiments, the hybrid scheduling system 118 and OS scheduler 202 may determine deadlines (e.g., runtime estimates) associated with vRAN workloads based on worst case execution times of individual processing tasks. In one or more embodiments, this is performed by observing vRAN traffic characteristics in real-time and determining estimated runtimes based on the observed traffic characteristics. As will be discussed in further detail below, in one or more implementations, the hybrid scheduling system 118 implements or otherwise utilizes a real-time scheduling model including a machine learning model to predict the worst-case execution time. In one or more embodiments, the real-time scheduling model includes quantile decision trees to identify latency parameters (e.g., tail latency) of runtimes of individual tasks, which may be considered (e.g., in combination of a workload) to determine the estimated runtime(s).

In addition to worst case execution times, the hybrid scheduling system 118 may take into account transmission deadlines for vRAN workloads when determining an order of varying tasks for the workloads. For example, the hybrid scheduling system 118 and OS scheduler 202 may apply different levels of priority to vRAN workloads and ensure that certain tasks are performed or otherwise processed sooner than other tasks as soon as processing resources (e.g., CPUs) become available. In the event that a task is taking longer than expected, the hybrid scheduling system 118 may dynamically increase the quantity of computing resources that are allocated to a vRAN VM (or individual vCPUs) to ensure that the task is completed by a transmission deadline.

In one or more embodiments, the hybrid scheduling system 118 and OS scheduler 202 make scheduling decisions and generate scheduling instructions in accordance with a predetermined time interval. For example, in one or more embodiments, scheduling decisions are made every 20 microseconds, which allows the hybrid scheduling system 118 and/or OS scheduler 202 to intervene and proactively acquire more CPU cores for a particular vCPU (or VM) where the vCPU is on track to miss a deadline (e.g., due to a misprediction of the expected CPU requirements).

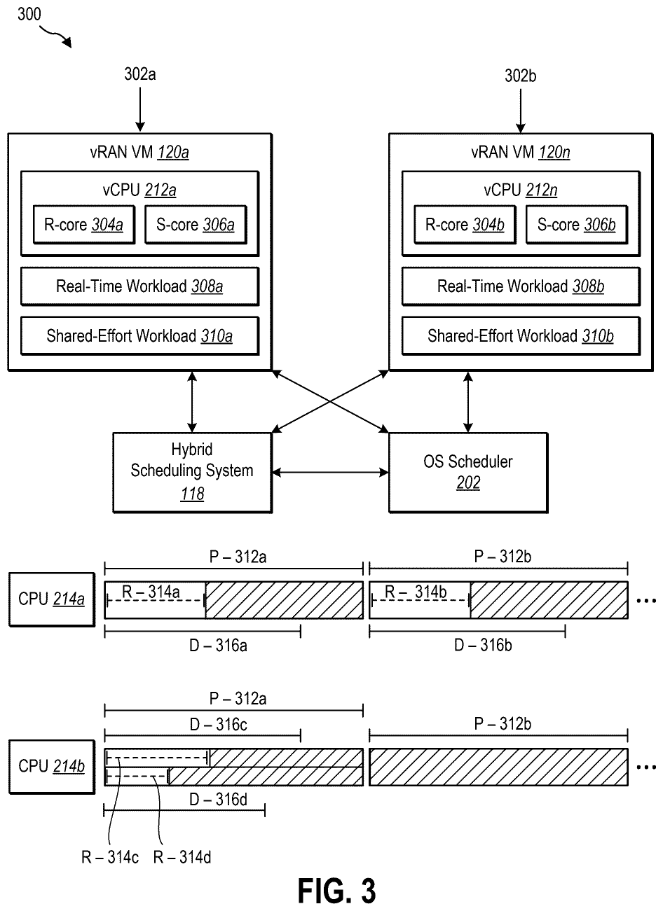

Additional detail will now be discussed in connection with various example implementations in which the hybrid scheduling system 118 may implement effective scheduling of computing resources between multiple VM real-time workloads. For example, FIG. 3 illustrates an example implementation in which the hybrid scheduling system 118 determines an estimated runtime based on KPIs determined and otherwise inferred from telemetry data and cooperatively schedules computing resources (e.g., CPUs 214a, 214b) for vCPU 212a of vRAN VM 120a and vCPU 212n of vRAN VM 120n to perform various workload tasks. In particular, FIG. 3 illustrates an example workflow 300 in which the hybrid scheduling system 118 coordinates scheduling of processing resources (e.g., CPUs 214a, 214b) for processing multiple real-time workloads of separate vRAN VMs 120a, 120n. In this example, the vRAN VM 120a receives packets 302a to be processed using the vCPU 212a, while the vRAN VM 120n receives packets 302b to be processed using the vCPU 212n. Other implementations may include fewer or additional vCPUs on either or both of the vRAN VMs 120a, 120n.

As discussed above, the hybrid scheduling system 118 enables the configuration of R-cores (e.g., real-time cores) and S-cores (e.g., shared cores) as part of a vCPU. For example, as shown in FIG. 3, the vCPU 212a can be designated as including an R-core 304a and an S-core 306a, while the vCPU 212n can be designated as including an R-core 304b and an S-core 306b. As discussed above, the hybrid scheduling system 118 maps the R-cores 304a, 304b and the S-cores 306a, 306b to processing resources of the physical CPUs 214a, 214b, respectively. During processing of workloads, the hybrid scheduling system 118 further generates scheduling instructions for the OS scheduler 202 that ensure demanding real-time workloads will not be sent to the same physical CPU for processing.

For example, as shown in FIG. 3, the vRAN VM 120a may receive packets 302a (e.g., telemetry data and other KPIs) in connection with a real-time workload 308a and a shared-effort workload 310a. From this data the hybrid scheduling system 118 can determine a runtime 314a and a deadline 316a for the real-time workload 308a. Similarly, the hybrid scheduling system 118 can determine a runtime 314b and a deadline 316b for the shared-effort workload 310a. Additionally, and concurrent with the vRAN VM 120a receiving the packets 302a (e.g., telemetry data and other KPIs), the vRAN VM 120n may receive packets 302b (e.g., telemetry data and other KPIs) in connection with a real-time workload 308b and a shared-effort workload 310b. As with the vRAN VM 120a, the hybrid scheduling system 118 can determine a runtime 314c and a deadline 316c for the real-time workload 308b, as well as a runtime 314d and a deadline 316d for the shared-effort workload 310b.

In one or more embodiments, the hybrid scheduling system 118 can generate scheduling instructions for processing the real-time workload 308a on the R-core 304a and for processing the shared-effort workload 310a on the S-core 306a. As mentioned above, the hybrid scheduling system 118 previously mapped the R-core 304a and the S-core 306a to the processing resources of the physical CPU 214a. As such, the hybrid scheduling system 118 can generate scheduling instructions that cause the OS scheduler 202 to process the real-time workload 308a on the CPU 214a during a first period 312a, and then to process the shared-effort workload 310a on the CPU 214a during a second period 312b.

As discussed above, by utilizing CPU paravirtualization and defining the R-cores 304a, 304b and the S-cores 306a, 306b across the vCPUs 212a, 212b, the hybrid scheduling system 118 can guarantee that demanding real-time workloads will not be processed at the same time on the same physical CPU. As such, and as shown in FIG. 3, the hybrid scheduling system 118 can generate scheduling instructions that ensure the real-time workload 308b will not be processed on the CPU 214a at the same time as the real-time workload 308a. Instead, the hybrid scheduling system 118 can generate scheduling instructions that cause the real-time workload 308a to be processed on the CPU 214b during the first period 312a.

Additionally, in some implementations and as mentioned above, the CPU paravirtualization approach can allow for shared-effort workloads to be collocated on the same physical CPU as a real-time workload. As such, the hybrid scheduling system 118 can generate scheduling instructions that cause the OS scheduler 202 to instruct the CPU 214b to process the real-time workload 308b and the shared-effort workload 310b during the first time period 312a. It follows that the CPU 214b is idle during the second time period 312b.

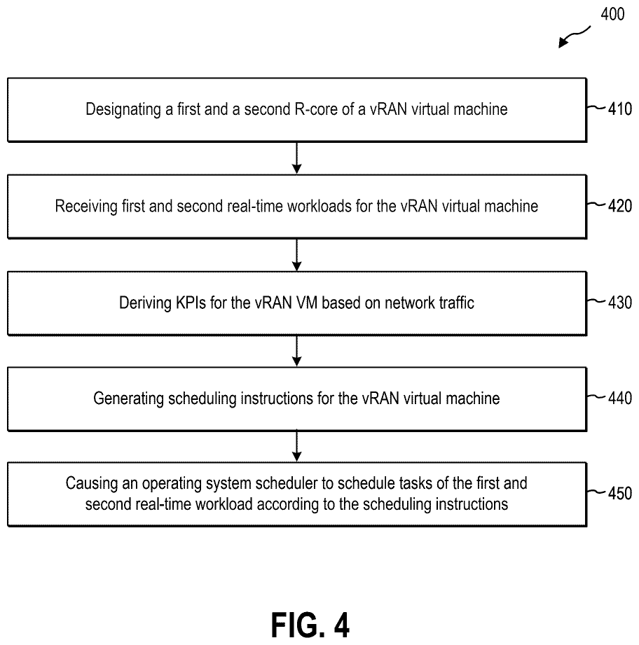

Turning now to FIG. 4, this figure illustrates an example flowchart including a series of acts 400 for enabling multiple real-time workloads of a vRAN VM to be processed without violating deadline scheduling. In particular, FIG. 4 illustrates a series of acts 400 in which the hybrid scheduling system 118 designates multiple R-cores of a vRAN VM to separate physical processors or CPUs of a server device. After receiving multiple real-time workloads, the hybrid scheduling system 118 derives KPIs for the vRAN VM based on network traffic and generates scheduling instructions for performing the real-time workloads on the R-cores based on the derived KPIs. While FIG. 4 illustrates acts 400 according to one or more embodiments, alternative embodiments may omit, add to reorder, and/or modify any of the acts 400 shown in FIG. 4. The acts 400 of FIG. 4 may be performed as part of a method. Alternatively, a non-transitory computer-readable medium can include instructions thereon that, when executed by one or more processors, cause a server device and/or client device to perform the acts 400 of FIG. 4. In still further embodiments, a system can perform the acts 400 of FIG. 4.

As shown in FIG. 4, a series of acts 400 includes an act 410 of designating a first and a second R-core of a vRAN virtual machine. In one or more embodiments, the act 410 includes designating a first R-core and a second R-core of a vRAN virtual machine (VM) operating on a server device. For example, designating the first R-core and the second R-core of the vRAN VM can include mapping the first R-core to a first physical processor or CPU of the server device, mapping the second R-core to a second physical processor or CPU of the server device, and implementing a mapping policy that the first real-time workload cannot be collocated with the second real-time workload on the first physical processor or the second physical processor.

As shown in FIG. 4, the series of acts 400 further includes an act 420 of receiving first and second real-time workloads for the vRAN virtual machine. In one or more embodiments, the act 420 includes receiving a first real-time workload for the vRAN VM and a second real-time workload for the vRAN VM. For example, as discussed above, real-time workloads are typically more processor intensive. As such, the hybrid scheduling system 118 can reserve R-cores for processing one real-time workload at a time.

As shown in FIG. 4, the series of acts 400 further includes an act 430 of deriving KPIs for the vRAN VM based on network traffic. In one or more embodiments, the act 430 includes deriving a plurality of KPIs for the vRAN VM based on network traffic between the vRAN VM and one or more virtual network functions, and utilization data from multiple processing layers associated with the vRAN VM. For example, deriving the plurality of KPIs for the vRAN VM based on network traffic between the vRAN VM and the one or more virtual network functions, and utilization data from multiple processing layers associated with the vRAN VM can include deriving the plurality of KPIs from downlink traffic from the vRAN VM to the one or more virtual network functions and deriving the plurality of KPIs from uplink traffic to the vRAN VM from the one or more virtual network functions.

In one or more embodiments, deriving the plurality of KPIs from the downlink traffic from the vRAN VM to the one or more virtual network functions includes mirroring the downlink traffic from the vRAN VM, and deriving user throughput KPIs from packets of the mirrored downlink traffic. Additionally, in one or more embodiments, deriving the plurality of KPIs from the uplink traffic to the vRAN VM from the one or more virtual network functions includes identifying IQ samples of fronthaul packets of the uplink traffic, and inferring uplink traffic load from energy levels indicated by the IQ samples.

As shown in FIG. 4, the series of acts 400 includes an act 440 of generating scheduling instructions for the vRAN virtual machine. In one or more embodiments, the act 440 includes generating scheduling instructions for the vRAN virtual machine to perform tasks of the first real-time workload and tasks of the second real-time workload on the first R-core and the second R-core based on the derived plurality of KPIs.

As shown in FIG. 4, the series of acts 400 includes an act 450 of causing an operating system scheduler to schedule tasks of the first and second real-time workload according to the scheduling instructions. In one or more embodiments, the act 450 includes causing an operating system (OS) scheduler of an OS of the server device to schedule the tasks of the first real-time workload and the tasks of the second real-time workload according to the scheduling instructions.

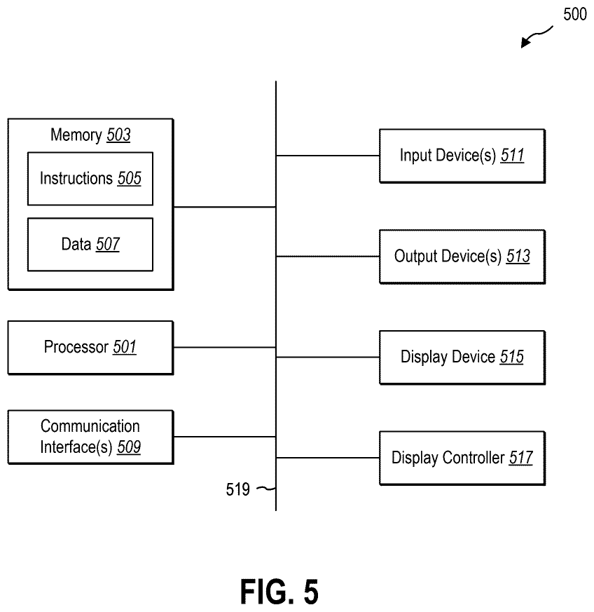

FIG. 5 illustrates certain components that may be included within a computer system 500. One or more computer systems 500 may be used to implement the various devices, components, and systems described herein.

The computer system 500 includes a processor 501. The processor 501 may be a general-purpose single-or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 501 may be referred to as a central processing unit (CPU). Although just a single processor 501 is shown in the computer system 500 of FIG. 5, in an alternative configuration, a combination of processors (e.g., an ARM and DSP) could be used.

The computer system 500 also includes memory 503 in electronic communication with the processor 501. The memory 503 may be any electronic component capable of storing electronic information. For example, the memory 503 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 505 and data 507 may be stored in the memory 503. The instructions 505 may be executable by the processor 501 to implement some or all of the functionality disclosed herein. Executing the instructions 505 may involve the use of the data 507 that is stored in the memory 503. Any of the various examples of modules and components described herein may be implemented, partially or wholly, as instructions 505 stored in memory 503 and executed by the processor 501. Any of the various examples of data described herein may be among the data 507 that is stored in memory 503 and used during execution of the instructions 505 by the processor 501.

A computer system 500 may also include one or more communication interfaces 509 for communicating with other electronic devices. The communication interface(s) 509 may be based on wired communication technology, wireless communication technology, or both. Some examples of communication interfaces 509 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 500 may also include one or more input devices 511 and one or more output devices 513. Some examples of input devices 511 include a keyboard, mouse, microphone, remote control device, button, joystick, trackball, touchpad, and lightpen. Some examples of output devices 513 include a speaker and a printer. One specific type of output device that is typically included in a computer system 500 is a display device 515. Display devices 515 used with embodiments disclosed herein may utilize any suitable image projection technology, such as liquid crystal display (LCD), light-emitting diode (LED), gas plasma, electroluminescence, or the like. A display controller 517 may also be provided, for converting data 507 stored in the memory 503 into text, graphics, and/or moving images (as appropriate) shown on the display device 515.

The various components of the computer system 500 may be coupled together by one or more buses, which may include a power bus, a control signal bus, a status signal bus, a data bus, etc. For the sake of clarity, the various buses are illustrated in FIG. 5 as a bus system 519.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

As used herein, non-transitory computer-readable storage media (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. In a telecommunication network including virtualized radio access network (vRAN) components running on servers of the telecommunication network, a method comprising:
designating a first real-time core (R-core) and a second R-core of a vRAN virtual machine (VM) operating on a server device;
receiving a first real-time workload for the vRAN VM and a second real-time workload for the vRAN VM;
deriving a plurality of key performance indicators (KPIs) for the vRAN VM based on network traffic between the vRAN VM and one or more virtual network functions, and utilization data from multiple processing layers associated with the vRAN VM;
generating scheduling instructions for the vRAN virtual machine to perform tasks of the first real-time workload and tasks of the second real-time workload on the first R-core and the second R-core based on the derived plurality of KPIs; and
causing an operating system (OS) scheduler of an OS of the server device to schedule the tasks of the first real-time workload and the tasks of the second real-time workload according to the scheduling instructions.

2. The method as recited in claim 1, wherein designating the first R-core and the second R-core of the vRAN VM comprises:
mapping the first R-core to a first physical processor of the server device;
mapping the second R-core to a second physical processor of the server device; and
implementing a mapping policy that the first real-time workload cannot be collocated with the second real-time workload on the first physical processor or the second physical processor.

3. The method as recited in claim 2, further comprising designating a first shared core (S-core) of the vRAN VM operating on the server device.

4. The method as recited in claim 3, wherein designating the first S-core of the vRAN VM comprises:
mapping the first S-core to a third physical processor of the server device; and
updating the mapping policy to reflect that two or more best-effort workloads can be collocated on the third physical processor, and that best-effort workloads can be collocated on the first physical processor and the second physical processor with the first real-time workload or the second real-time workload.

5. The method as recited in claim 1, wherein deriving the plurality of KPIs for the vRAN VM based on network traffic between the vRAN VM and the one or more virtual network functions, and utilization data from multiple processing layers associated with the vRAN VM comprises deriving the plurality of KPIs from downlink traffic from the vRAN VM to the one or more virtual network functions and deriving the plurality of KPIs from uplink traffic to the vRAN VM from the one or more virtual network functions.

6. The method as recited in claim 5, wherein deriving the plurality of KPIs from the downlink traffic from the vRAN VM to the one or more virtual network functions comprises:
mirroring the downlink traffic from the vRAN VM; and
deriving user throughput KPIs from packets of the mirrored downlink traffic.

7. The method as recited in claim 5, wherein deriving the plurality of KPIs from the uplink traffic to the vRAN VM from the one or more virtual network functions comprises:
identifying IQ samples of fronthaul packets of the uplink traffic; and
inferring uplink traffic load from energy levels indicated by the IQ samples.

8. The method as recited in claim 1, wherein the multiple processing layers associated with vRAN VM comprise a physical layer (PHY) and at least one additional processing layer.

9. The method as recited in claim 8, wherein the at least one additional processing layer comprises one or more of a radio resource allocation/reliability layer (MAC/RLC), a convergence/security layer (PDCP), a quality of service layer (SDAP), and a mobile core communication (NAS) layer.

10. The method as recited in claim 1, wherein the telecommunication network is a 5G mobile network.

11. A system, comprising:
at least one processor;
memory in electronic communication with the at least one processor; and
instructions stored in memory, the instructions being executable by the at least one processor to:
designate a first real-time core (R-core) and a second R-core of a vRAN VM operating on a server device;
receive a first real-time workload for the vRAN VM and a second real-time workload for the vRAN VM;
derive a plurality of key performance indicators (KPIs) for the vRAN VM based on network traffic between the vRAN VM and one or more virtual network functions, and utilization data from multiple processing layers associated with the vRAN VM;
generate scheduling instructions for the vRAN VM to perform tasks of the first real-time workload and tasks of the second real-time workload on the first R-core and the second R-core based on the derived plurality of KPIs; and
cause an OS scheduler of an OS of the server device to schedule the tasks of the first real-time workload and the tasks of the second real-time workload according to the scheduling instructions.

12. The system as recited in claim 11, the instructions being further executable by the at least one processor to designate the first R-core and the second R-core of the vRAN VM by:
mapping the first R-core to a first physical processor of the server device;
mapping the second R-core to a second physical processor of the server device; and
implementing a mapping policy that the first real-time workload cannot be collocated with the second real-time workload on the first physical processor or the second physical processor.

13. The system as recited in claim 12, wherein the instructions are further executable by the at least one processor to designate a first shared cores (S-cores) of the vRAN VM operating on the server device by:
mapping the first S-core to a third physical processor of the server device; and
updating the mapping policy to reflect that two or more best-effort workloads can be collocated on the third physical processor, and that best-effort workloads can be collocated on the first physical processor and the second physical processor with the first real-time workload or the second real-time workload.

14. The system as recited in claim 11, the instructions being further executable by the at least one processor to derive the plurality of KPIs for the vRAN VM based on network traffic between the vRAN VM and the one or more virtual network functions, and utilization data from multiple processing layers associated with the vRAN VM by deriving the plurality of KPIs from downlink traffic from the vRAN VM to the one or more virtual network functions and deriving the plurality of KPIs from uplink traffic to the vRAN VM from the one or more virtual network functions.

15. The system as recited in claim 14, wherein deriving the plurality of KPIs from the downlink traffic from the vRAN VM to the one or more virtual network functions comprises:
mirroring the downlink traffic from the vRAN VM; and
deriving user throughput KPIs from packets of the mirrored downlink traffic.

16. The system as recited in claim 14, wherein deriving the plurality of KPIs from the uplink traffic to the vRAN VM from the one or more virtual network functions comprises:
identifying IQ samples of fronthaul packets of the uplink traffic; and
inferring uplink traffic load from energy levels indicated by the IQ samples.

17. The system as recited in claim 11, wherein the multiple processing layers associated with vRAN VM comprise a physical layer (PHY) and at least one additional processing layer.

18. The system as recited in claim 17, wherein the at least one additional processing layer comprises one or more of a radio resource allocation/reliability layer (MAC/RLC), a convergence/security layer (PDCP), a quality of service layer (SDAP), and a mobile core communication (NAS) layer.

19. The system as recited in claim 11, wherein the server device exists within a telecommunication network.

20. In a fifth generation (5G) mobile communication network including vRAN components running on servers of the 5G mobile communication network, a method comprising:
designating a first real-time core (R-core) and a second R-core of a vRAN virtual machine (VM) operating on a server device;
receiving a first real-time workload for the vRAN VM and a second real-time workload for the vRAN VM;
deriving a plurality of key performance indicators (KPIs) for the vRAN VM based on network traffic between the vRAN VM and one or more virtual network functions, and utilization data from multiple processing layers associated with the vRAN VM;
generating scheduling instructions for the vRAN virtual machine to perform tasks of the first real-time workload and tasks of the second real-time workload on the first R-core and the second R-core based on the derived plurality of KPIs; and
causing an operating system (OS) scheduler of an OS of the server device to schedule the tasks of the first real-time workload and the tasks of the second real-time workload according to the scheduling instructions.
